(19) United States
(12) Patent Application Publication
(10) Pub. No.: US 2004/0210655 A1
(43) Pub. Date: Oct. 21, 2004

(54) Device for managing parameter measurement in end-to-end type data streams in a multidomain communication network

(75) Inventors: Olivier Martinot, Draveil (FR); Stephane Betge-Brezetz, Paris (FR); Michel Chevanne, Clamart (FR); Gerard Delegue, Cachan (FR); Emmanuel Marilly, Antony (FR)

Correspondence Address: SUGHRUE MION, PLLC, 2100 Pennsylvania Avenue, N.W., Suite 800, Washington, DC, 20037-3213, US

(73) Assignee: ALCATEL

(21) Appl. No.: 10/825,243

(22) Filed: Apr. 16, 2004

(30) Foreign Application Priority Data
Apr. 18, 2003 (FR) 03 04 854

(51) Int. Cl. G06F 15/16; G06F 15/173

(52) U.S. Cl. 709/224; 709/231; 709/249

(57) ABSTRACT

A device (D) is dedicated to managing the measurement of parameters in end-to-end data streams in a communication network (N) composed of at least two domains (Ai) coupled together and each equipped with a measuring appliance (Mi) delivering local measurements representing the parameter values of local end-to-end type data streams, where the measuring appliances (Mi) are implementing different measuring processes. The device (D) includes, firstly, monitoring means (MM) which are responsible for ordering the institution of a specific measurement configuration in each measuring appliance in accordance with at least its measuring process and with overall measurement specifications, and secondly, calculation means (CM) which are responsible for delivering first data representing the parameter values of end-to-end type data streams from local measurements delivered by the configured measuring appliances (Mi).

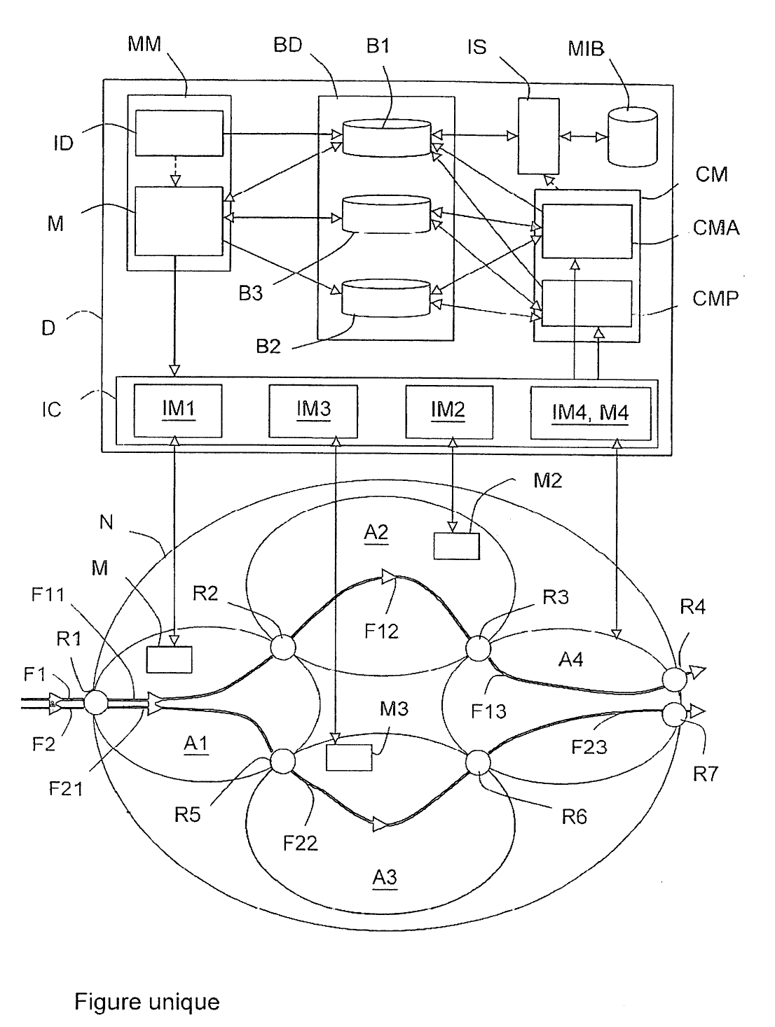

### BACKGROUND OF THE INVENTION

The invention concerns communication networks of the multi domain type, and more particularly those for which the operators have concluded service-level agreements with their customers concerning compliance with a given quality of service (QoS).

The network operators place at the disposal of their customers numerous communication networks which are frequently coupled together by means of intermediate equipment such as edge routers. These coupled networks, which are frequently of different types, in fact constitute a “supernetwork” which is more commonly known as a “multi domain” network (given that each network then comprises one domain).

Furthermore, the operators generally offer their customers service-level agreements (SLAs) through which they undertake to guarantee a certain quality of service (QoS) which is defined by the values of network parameters such as instability or jitter, loss of packets and transmission delays.

Some of these agreements even concern compliance with a quality of service which is predefined during the passage through one or several coupled communication networks.

In order to enable compliance with these quality of service commitments during the passage through a network, the communication networks are generally equipped with a measuring appliance which is responsible for performing measurements, known as end-to-end measurements, of certain network parameters. The measuring process implemented by such an appliance generally depends on the type of network subjected to the measurements. To be more precise, there exist three types of measuring processes.

A first type consists of performing passive measurements on all streams and all packets at the ingress point (input) and the egress point (output) of the network (or domain). This process is particularly precise, since it covers the entirety of the stream in transit. Measuring appliances which implement this process are commercialised in the form of “middle boxes” by the Fidelia, Brix Network and Ipanema companies in particular.

A second type consists of regularly performing active measurements by transmitting an additional marked stream between the inputs and outputs. Since this process uses an additional dedicated stream, it therefore allows only average values to be delivered. However the marked streams can be of different types, in order to be more representative of the different types of actual streams (TCP, UDP, DSCP, etc.). Measuring appliances which implement this process are commercialised by the Agilent and Cisco companies in particular.

A third type consists of performing measurements using a measurement model. This is created by modelling the network and the behaviour of the different types of stream within the said network. This process can be used to estimate some parameter values of some network streams of the end-to-end type, from some network parameters extracted from network equipment via their management information bases (MIBs) or via requests using dedicated commands of the command line interface (CLI) type.

Because of the diversity and the homogeneity of the networks, two or three of the aforementioned processes are able to coexist simultaneously in a multi domain network. Since the different domains of such a network are defined from technological and functional criteria which are generally different or even arbitrary, and generally not being linked by a common administrative criterion, there exists no solution which can be used to perform overall measurements on end-to-end type streams in a simple and automatic manner. By “overall measurements” is meant here any measurements performed on the passage through at least two coupled domains.

Therefore, the object of the invention is to remedy this drawback.

To this end, it provides a device for the management of measurements of the parameters of end-to-end type data streams, for a communication network which consists of at least two domains connected together, each equipped with a measuring appliance delivering local measurements which are representative of the parameter values of local end-to-end streams, where these measuring appliances implement different measuring processes.

By “local end-to-end stream” is meant here a data stream transiting between the inputs and outputs of one domain in a multi domain network. As a consequence, the expression “overall end-to-end stream” refers to a data stream transiting between the inputs and outputs of a multi domain network via at least two of its domains.

This device is characterised by the fact that it includes, firstly, monitoring means which are responsible for ordering the constitution of a specific measurement configuration in the measuring appliance of each network domain, in accordance with at least the measuring process which it is implementing and with overall measurement specifications, and secondly, computing means which are capable of delivering the first data (or overall measurements) which are representative of the parameter values of overall end-to-end streams from local measurements delivered by the various configured measuring appliances.

The management device according to the invention can have additional characteristics which can be taken separately and or in combination, and the following in particular:

monitoring means responsible for ordering the institution of a specific measurement configuration in each measuring appliance, also as a function of second data representative of the arrangement of its domain,

monitoring means which include the first interface resources used to define the overall measurement specifications,

monitoring means which include configuration means responsible for determining, for each measuring appliance, local measurement specifications defining its specific configuration to be instituted. In this case, the configuration means can also be responsible for determining the data representing the correspondence between the local measurement specifications and the overall measurement specifications,

storage means which define a first memory storing the data representing the overall measurement specifications. In this case, the storage means can also define a second memory storing data representing the local measurement specifications and/or configuration data. In addition, when at least one domain includes a measuring appliance implementing a measuring process based on a measurement model, then the storage means can also define a third memory, storing data representing this measurement model,

calculation means, including a main calculation module responsible for determining the first data (or overall measurements) from local measurements delivered by configured measuring appliances, local measurement specifications, and at least one value aggregation model, as well, where appropriate, as additional data defining an additional value aggregation model, for example. In this case, the data representing the value aggregation model and/or the additional value aggregation model are preferably stored in the second memory. Alternatively, the main calculation module can be made responsible for determining the first data (or overall measurements) from local measurements delivered by configured measuring appliances, local measurement specifications, and at least one value aggregation model and at least one of the measurement models, as well, where appropriate, as additional data defining an additional measurement model for example. In this case, the data representing the additional measurement model are preferably stored in a third memory,

Calculation means which include an auxiliary calculation module responsible for determining the second data, representing the respective contributions (relative and/or absolute) of the various domains to the first data (or overall measurements), from local measurements delivered by the configured measuring appliances and local measurement specifications. In this case, the second data are preferably stored in the first memory.

A first memory, preferably storing the first data,

An output interface coupled to the calculation means and capable of delivering the first and/or second data, on order, at its output. Alternatively, the output interface can extract, on order from the first memory, the first and/or the second data in order to deliver them to an output. In this case, one can also provide a management information database (MIB) to store the first and/or the second data delivered by the output of the output interface,

Second interface means arranged in the shape of interface modules, each dedicated to a measuring process, coupled to the monitoring means, to the measuring appliances and to the calculation means, and each responsible for configuring the corresponding measuring appliance and for collecting its local measurements in order to feed into the calculation means. One of these interface means can also constitute an external measurement means for a domain of the multi domain communication network.

The invention also concerns a multi domain communication network equipped with at least one management device of the type presented above.

In particular, the invention can be implemented in all network technologies which need to be managed in transmission networks (of the WDM, SONET or SDH type for example), data networks (of the Internet/IP or ATM type for example) or speech networks (of the conventional, mobile or NGN type for example).

Other characteristics and advantages of the invention will appear on examination of the detailed description below, and of the appended drawing on which the FIGURE schematically illustrates a multi domain communication network equipped with a network management device according to the invention. The appended drawing can not only serve as part of the invention but can also contribute to its description where appropriate.

The purpose of the invention is to enable centralised management of the measurement parameters of end-to-end type data streams in a communication network of the multi domain type with multiple measuring processes.

In the non-limited example illustrated in the single FIGURE, the communication network (N) is composed of four communication networks (A1 to A4), called domains, coupled together by network equipment of the peripheral or edge router type (R). The invention is not limited to a number (i) of domains (Ai) equal to four. This number (i) can in fact take any value of two or more.

Furthermore, in this example, we have described a first overall stream (F1) between domains A1 and A4 via domain A2, and a second overall stream (F2) between domains A1 and A4 via domain A3. These overall streams (F1 and F2) are known as “end-to-end” streams, to the extent that they pass through the entire network (N) via at least two of its domains (Ai). Each overall stream (F1, F2) can be broken down here into three local stream portions, also of the end-to-end type, to the extent that these portions each traverses one domain (Ai) completely.

More precisely, the overall stream (F1) can be divided, firstly, into a first local stream portion (F11) associated with domain A1 and defined between (input) edge router R1 and another edge router (R2), and secondly into a second local stream portion (F12) associated with domain A2, and defined between edge router R2 and another edge router (R3), and thirdly, into a third local stream portion (F13) associated with domain A4 and defined between edge router R3 and another (output) edge router (R4),

Likewise, the overall stream (F2) can be divided, firstly, into a first local stream portion (F21) associated with domain A1 and defined between (input) edge router R1 and another edge router (R5), and secondly into a second local stream portion (F22) associated with domain A3 and defined between edge router R5 and another edge router (R6), and thirdly, into a third local stream portion (F23) associated with domain A4 and defined between edge router R6 and another (output) edge router (R7).

The first domain (A1) is equipped with a measuring appliance (Ml) which is responsible for performing local measurements on the values taken by the parameters of local end-to-end streams (F11 and F12). For example, this measuring appliance (M1) implements a measuring process based upon a measurement model which has been prepared from modelling of the first network (or domain, A1) and the behaviour of the various types of stream which transit within this domain (A1). Such a measuring process is used to estimate some parameter values of end-to-end streams from some parameters of network A1, extracted from certain of its network equipment (routers, switches, servers, etc.) via their management information databases (MIB) or via requests based upon dedicated commands of the command line interface (CLI) type for example.

The second domain (A2) is equipped with a measuring appliance which is responsible for performing local measurement of values taken by the parameters of the local end-to-end streams (F12). For example, this measuring appliance (M2) implements a measuring process based on the passive measurement of all types of stream (F12) and all of their packets. It is therefore connected to the edge routers (R2 and R3) in which observation agents are installed or to which they are connected. Measuring appliances which implement this passive measuring process are commercialised in the form of “middle boxes” by the Fidelia, Brix Network and Ipanema companies in particular. The detailed operation of these middle boxes can be found at internet addresses:

“http://www.ipanematech.com”,

“http://www.brixnetworks.com”, and

“http://www.fidelia.com/news_updates/netvigil.phtml” in particular.

The third domain (A3) is equipped with a measuring appliance (M3) which is responsible for the local measurement of values taken by parameters of the local end-to-end streams (F22). For example, this measuring appliance (M3) implements a measuring process based on active measurements carried out regularly (periodically) between the input router (R5) and the output router (R6) on the additional “tagged” stream. These active measurements are performed by observation agents installed in the edge routers (R5 and R6) or connected to them. This process delivers measurements which are representative of average values. Several types of tagged stream are generally used in order to be representative of the different types of stream (TCP, UDP, DCSP, etc.) which actually transit through the domain (A3). Measuring appliances which implement this active measuring process are commercialised by the Allot, Cisco, Agilent and NetlQ companies in particular. The detailed operation of these appliances can be found at internet addresses:

“http://www.allot.com”,

“http://www.cisco.com/warp/public/126/saa.html”,

“http://www.agilent.com/cm/rdmfg/firehunter/” and

“http://www.netiq.com/products/chr/default.asp” in particular.

The fourth domain (A4) is equipped with a measuring appliance (M4) which is responsible for performing local measurements on the values taken by the parameters of the local end-to-end streams (F13 and F23). For example, this measuring appliance (M4) implements a measuring process based on the passive measurement of all types of stream (F13 and F23) and all of their packets. In this example, the measuring appliance (M4) is remoted or external, and more precisely, is integrated into the management device or arrangement (D) according to the invention, which will be described thereafter.

In what follows, it is considered that the multi domain network (N) is a network of the internet/IP type. However the invention also applied to other types of network, such as transmission networks of the WDM, SONET or SDH type, for example, or of the ATM data type, or of the conventional, mobile or NGN type, and to other network management protocols such as, for example, TL1, CORBA or CMISE/CMIP.

The invention provides a device or arrangement (D) which is responsible for configuring the various types of measuring appliances (Mi) in accordance with overall specifications for measuring the parameters of overall end-to-end data streams, and to collect the local measurements delivered by these configured measuring appliances (Mi) in order to deliver the first data (or overall measurements) representing the parameter values of the overall end-to-end streams corresponding to the overall specifications.

To this end, the device (D) includes monitoring means (MM) which are responsible for ordering the constitution of a specific measurement configuration in the measuring appliance (Mi) of each domain in the network (N), and preferably, as will be seen later, for determining each specific configuration, and the calculation means (CM) for determining the first data (or overall measurements) from, in particular, local measurements delivered by the different configured measuring appliances (Mi).

More precisely, in the embodiment illustrated, the monitoring means (MM) include firstly a definition interface (ID) which enables an operator to define the overall specifications of the measurement parameters of the end-to-end streams within the multi domain network (N). The overall specifications, which are characteristic of the end-to-end measurements, mainly define the transmission delay, the jitter, the end-to-end packet loss, and the associated statistics (maximum, minimum, average, standard deviation, etc.).

More preferably, the device (D) includes storage means (BD) which include a first memory (B1) in which the data representing the overall specifications of the measurements delivered by the output of the definition interface (ID) are stored.

The monitoring means (MM) also include a configuration module (MC) which is responsible for determining a specific configuration to be put in place for each measuring appliance (Mi). To this end, the configuration module (MC) should preferably be coupled to the first memory (B1). It is thus able to extract from it the data representing the overall specifications of the measurements so as to determine local specifications of the measurements defining each measuring appliance configuration (Mi). This determination takes account of the measuring process implemented by the measuring appliance (Mi) concerned, as well as, preferably, the hardware and functional arrangement of the domain (Ai) equipped with the said appliance (Mi).

A set of rules defined by the operator can be used, for example, to determine, in each domain (Ai), how the local measurement is deduced as a function of the overall specification, the type of service (application type, class of service, etc.) and the type of customer.

More preferably, the storage means (BD) include a second memory (B2) in which the data representing the local specifications of the measurements determined by the configuration module (MC) are stored.

It is important to note that the local specifications that define the configurations of the measuring appliances (Mi) which are implementing a measuring process based upon a measurement model, are also defined in accordance with the measurement model concerned. As a consequence, the data representing the measurement models, used by some measuring appliances (Mi-here M1) of the multi domain network (N) should preferably be stored in a third memory (B3) of the memory means (BD), coupled to the configuration module (MC) in particular.

Depending on the measurement model implemented, the measurement model is a model which makes the characteristic of an end-to-end stream, and the path taken by this stream where appropriate, as well as the measurement specification (delay, jitter, etc.) corresponds with the specification of the local measurement.

The configuration module (MC) can also be configured so as to determine the correspondence data representing the correspondence between the local measurement specifications, which they have determined, and the overall measurement specifications obtained from the first memory (B1). For example, in the case of domain A1, correspondence occurs between the characteristic of the stream and a set of elementary measurements used to calculate the value corresponding to the local measurement specifications.

These configuration data are preferably stored in the second memory (B2).

It is important to note that the configuration module (MC) could be coupled to the definition interface (ID) in order to be supplied directly with overall specifications.

More preferably the management device (G) includes a configuration interface (IC), coupled to the configuration module (MC) and arranged in the shape of interface modules (IMj), each of which is dedicated to one type of measuring process. This configuration interface (IC) is also coupled to the calculation means (CM) so as to supply them with the local measurements, collected by its interface modules (IMj) from the various measuring appliances (Mi) in the domains (Ai) of the multi domain network (N).

In the example illustrated, the configuration interface (IC) includes four interface modules (IMj, where j=1 to 4).

A first interface module (IM1) is responsible for configuring all of the appliances (Mi) of the multi domain network (N), implementing a measuring process based upon a measurement model, with local specifications which have been determined for this purpose by the configuration module (MC). As a result, the first interface module (IM1) is coupled to all of the measuring appliances (Mi) of the aforementioned type (here, only M1 is concerned). It sends them the local specifications using an exchange protocol such as Simple Network Management Protocol (SNMP) RFC 2571-2580, and collects their measurements in order to communicate them to the calculation means (CM).

It is important to note that the first interface module (IM1) can collect only the information data extracted from the equipment elements of domain A1, which are used by the corresponding measurement model. In this case, the local measurement is performed either by the first interface module (IM1) or by the calculation means (CM), the latter being preferable.

A second interface module (IM2) is responsible for configuring the appliances (Mi) which are installed within the domains (Ai) of the multi domain network (N), and implementing a passive measuring process, with local specifications which have been determined for this purpose by the configuration module (MC). Therefore, the second interface module (IM2) is coupled to all of the measuring appliances (Mi) of the aforementioned type (here, only M2 is concerned), preferably via their management information databases (MIB) in which their local measurements are stored. It sends them the local specifications using an exchange protocol such as the SNMP for example, and collects their measurements in order to communicate them to the calculation means (CM).

A third interface module (IM3) is responsible for configuring the appliances (Mi) which are installed within the domains (Ai) of the multi domain network (N), and implementing an active measuring process, with local specifications which have been determined for this purpose by the configuration module (MC). Therefore, the third interface module (IM3) is coupled to all of the measuring appliances (Mi) of the aforementioned type (here, only M3 is concerned). It sends them the local specifications using an exchange protocol such as the SNMP for example, and collects their measurements in order to communicate them to the calculation means (CM).

A fourth interface module (IM4) is used here as an external (or remote) measuring appliance (M4), implementing a passive measuring process for the fourth domain (A4). In other words, it configures itself with the local specifications which have been determined for this purpose by the configuration module (MC). This fourth interface module (IM4) is coupled only to the fourth domain (A4), and in particular to its edge routers (R3, R4, R6 and R7), in which observation agents are installed, or to which they are connected, and communicates its own measurements to the calculation means (CM).

It is important to note that the use of an external or remote measuring appliance, integrated into an interface module (IM4), is suitable for situations in which the exchange protocol with the observation agents, installed in the edge routers, is fully known.

It is also possible to provide an automatic search procedure for the configuration capacities of the various measuring appliances (Mi) of the multi domain network (N), so as to facilitate the creation of local configurations for the said measuring appliances by the configuration module (MC). In this case, the configuration means (MM) include a search stage, coupled to the configuration module (MC) and to the configuration interface (IC), and responsible, when the configuration module (MC) so requires, for executing the search for the configuration capacities of the measurement means (Mi) of the network (N). This requires the installation of search means for information concerning the capacities of the equipment.

The calculation means (CM) include a main calculation module (MCP) which is responsible for determining the first data (or overall measurements) from local measurements delivered by the configured measuring appliances (Mi).

More precisely, the main calculation module (MCP) effects its determinations by taking account of at least the local configurations proper to each measuring appliance (Mi), and whose representative data are stored in the second memory (B2). This is the case in particular when the measuring appliances (Mi, here M1 to M4) implement an active or passive measuring process.

When the measuring process is based upon a measurement model, the main calculation module (MCP) effects its determination taking account of the local configurations proper to the corresponding measuring appliance (Mi, here M1), and of the corresponding measurement model, whose data are stored in the third memory (B3).

The local measurements received from the configuration interface (IC) can be subjected to a process or transformation where appropriate. They are then subjected to an aggregation process intended to supply the first data (or overall measurements) representing the overall measurements of the end-to-end streams which characterise the overall streams (F1 and F2) during their passage through the multi domain network (N). These overall measurements are representative, for example, of the instability or jitter in the network (N), or the loss of packets, or transmission delay, as well as the associated statistics (maximum, minimum, average, standard deviation, etc.)

In order to effect this aggregation, the main calculation module (MCP) uses a value aggregation model whose representative data are preferably stored in the second memory (B2).

The aggregation model is quite simple when the overall measurement concerns a parameter of the additive type, such as delay. It then suffices to add together all of the local delay measurements in order to get the value of the overall delay induced by passing through the multi domain network (N). However it can be complex when the overall measurement concerns a non-additive parameter, such as standard deviation or a maximum value. In particular, overall precision can be deduced for the local aggregations effected by the measuring appliances (Mi) within their respective domains (Ai) using a model of the standard-deviation aggregation type (a model which makes the link between the overall measurement and the standard deviations associated with the local measurements).

In the case of overall stream F2, for example, the overall delay introduced by passage through the edge routers (R1 and R7) is obtained by aggregation, firstly of the delay introduced by the passage between edge routers R1 and R5, estimated by appliance M1 after extraction of the relevant parameters and application of the measurement model, secondly of the delay introduced by the passage between edge routers R5 and R6, whose average value is estimated by appliance M3, and thirdly of the delay introduced by the passage between edge routers R6 and R7, determined by appliance M4 installed in the fourth interface module (IM4).

The main calculation module (MCP) can also take account of the fact that a part located between two domains (Ai) has not been subjected to local measurements. This can be the case in particular when the measurements do not take account of the internal delay induced by a router, or from a router serving as the coupling interface between two edge routers belonging to two adjacent domains. In order to incorporate these omitted parts into the calculation of the first data (or overall measurements), the main calculation module (MCP) uses additional data defining a model for the aggregation of additional values. These additional data are preferably stored in a second memory (B2).

It is important to note that when the omitted part concerns a domain (Ai) which is subjected to measurements based upon a measurement model, it is preferable that the additional data should define an additional measurement model. These additional data are then preferably stored in the third memory (B3).

The overall measurements (or first data) delivered by the main calculation module (MCP) are preferably stored in the first memory (B1).

The calculation means can also include an auxiliary calculation module (CMA) which is responsible for determining the second data representing the respective contributions of the different domains (Ai), from the multi domain network (N), to the overall measurements (or first data). More precisely, the auxiliary calculation module (CMA) effects its determinations by taking account firstly of the local measurements delivered by the configured measuring appliances (Mi), and secondly the local configurations proper to each measuring appliance (Mi) whose representative data are stored in the second memory (B2) and, where appropriate, measurement models whose representative data are stored in the third memory (B3). The values of the local measurements, which are used incidentally to constitute the overall measurement, are preferably preserved in order to allow estimation of the relative (or absolute) weight of each of the domains in the overall measurement.

The determined contributions can be relative and/or absolute. These are preferably stored in the first memory (B1).

The management device (G) can also include, as illustrated, an output interface (IS) coupled to the first memory (B1) and/or to the calculation means (CM). The output interface (IS) is intended to deliver at its output the first data (overall measurements) and/or the second data (relative and/or absolute contributions).

The output interface (IS) preferably acts on the orders of an external equipment element, such as with the aid of commands of the command line interface (CLI) type, or indeed in an automatic manner when it is configured to this end. The external equipment can be the management server of the Network Management System (NMS) of the multi domain communication network (N), for example, which is responsible for continuously analysing the state of the resources and the performances of the network so as to anticipate or detect problems or breakdowns, and to determine the actions to be undertaken so that the customers of the network should not be penalised. The data delivered by the output interface (IS) then feeds the NMS layer, and particularly its data collector, that is directly (in this case, it constitutes a conventional database), or indirectly via a management information database (MIB) installed in the management device (D), and dedicated to the overall measurements or to a set of functions used to access the said overall measurements.

It is possible to envisaged however that the calculation means (CM) should deliver their first data (overall measurements) and second data (relative and/or absolute contributions) either directly at an output of the management device (D), destined for example for the data collector of the NMS layer, or at the output interface (IS), or indeed at the MIB.

Transmission of the results delivered by the management device (D), to the NMS layer for example, is effected with the aid of a management protocol such as the Simple Network Management Protocol (SNMP) RFC 2571-2580.

The management device (D) according to the invention, and particularly its configuration means (MM), its calculation means (CM), its storage means (BD), its configuration interface (IC) and its output interface (IS), can be implemented in the form of electronic circuits, software (or computer) modules, or a combination of circuits and software.

The invention is not limited to the embodiments described above by way of example only, for implementation of the multi domain communication network management device, but can encompass all of the variants that can be envisaged by any professional engineer in the context of the following claims.

1. A device (D) for managing the measurement of parameters of end-to-end type data streams in a communication network (N) composed of at least two domains (Ai) coupled together, and each equipped with a measuring appliance (Mi) capable of delivering local measurements representing parameter values of local end-to-end data streams, where said measuring appliances (Mi) implement various measuring processes, characterised in that it includes (i) monitoring means (MM) arranged so as to order the constitution of a specific measurement configuration in each measuring appliance (Mi) as a function of at least its measuring process and overall measurement specifications, and (ii) calculation means (CM) arranged so as to deliver first data representative of parameter values of overall end-to-end data streams from local measurements delivered by the said configured measuring appliances (Mi).

2. A device as in claim 1, characterised in that said monitoring means (MM) are arranged so as to order the constitution of a specific measurement configuration in each measuring appliance (Mi) as a function of its measuring process, second data representing the arrangement of its domain and overall measurement specifications.

3. A device as in claim 1, characterised in that said monitoring means (MM) include the first interface means (ID) arranged to allow the definition of said overall measurement specifications.

4. A device as in claim 1, characterised in that said monitoring means (MM) include configuration means (MC) arranged to determine, for each measuring appliance (Mi), the local specifications of measurements defining its specific configuration to be constituted.

5. A device as in claim 4, characterised in that said monitoring means (MM) are arranged to determine the corresponding data representing the correspondence between said local measurement specifications and said overall measurement specifications.

6. A device as in claim 1, characterised in that said storage means (BD) define a first memory (B1) capable of storing data representing said overall measurement specifications.

7. A device as in claim 6, characterised in that said storage means (BD) define a second memory (B2) capable of storing data representing said local measurement specifications and/or said configuration data.

8. A device as in claim 6, characterised in that in the presence of at least one domain (D1) which includes a measuring appliance (M1) implementing a measuring process based upon a measurement model, said storage resources (BD) define a third memory (B3) capable of storing the data representing said measurement model.

9. A device as in claim 4, characterised in that said calculation means (CM) include a main calculation module (CMP) arranged to determine said first data from local measurements delivered by said configured measuring appliances (Mi), said local measurement specifications and at least one value aggregation model.

10. A device or arrangement as in claim 9, characterised in that said main calculation module (CMP) is arranged to determine said first data from additional data.

11. A device as in claim 10, characterised in that said additional data define an aggregation model for additional values.

12. A device as in claim 9, characterised in that said second memory (B2) is capable of storing the data representing the said value aggregation model and/or of the said additional value aggregation model.

13. A device as in claim 8, characterised in that said main calculation module (CMP) is arranged to determine said first data from local measurements delivered by the said configured measuring appliances (Mi), the said local measurement specifications, at least one value aggregation model and at least one of said measurement models.

14. A device as in claim 10, characterised in that said additional data define an additional measurement model.

15. A device as in claim 14, characterised in that said third memory (B3) is capable of storing the data representing said measurement model and/or of the additional measurement model.

16. A device as in claim 4, characterised in that said calculation means (CM) include a auxiliary calculation module (CMA) arranged to determine second data representing the respective contributions of the various domains to the first data, from local measurement delivered by said configured measuring appliances (Mi) and said local measurement specifications.

17. A device as in claim 16, characterised in that said auxiliary calculation module (CMA) is arranged to determine second data representing relative contributions and/or absolute contributions.

18. A device as in claim 16, characterised in that said first memory (B1) is capable of storing said second data.

19. A device as in claim 6, characterised in that said first memory (B1) is capable of storing said first data.

20. A device as in claim 16, characterised in that it includes an output interface (IS) coupled to said calculation means (CM) and capable of delivering said first and/or second data at an output when so ordered.

21. A device or arrangement as in claim 16, characterised in that it includes an output interface (IS) which is capable of extracting the said first and/or second data from the first memory (B1) at an output when ordered to do so.

22. A device as in claim 20, characterised in that it includes a management information database (MIB) which is supplied with the first and/or second data by said output interface (IS).

23. A device as in claim 1, characterised in that it includes second interface resources (IC) arranged in the shape of interface modules (IMj), each dedicated to a measuring process, coupled to said monitoring means (MM) to said measuring appliances (Mi) and to said calculation means (CM), and each arranged to configure the corresponding measuring appliance (Mi) and to collect its local measurements in order to supply said calculation means (CM).

24. A device as in claim 23, characterised in that one of said interface modules (4) constitutes an external measuring appliance (M4) for a domain (A4) of said communication network (N).

25. A communication network (N) which includes at least two domains (Ai) coupled together and each equipped with a measuring appliance (Mi) capable of delivering local measurements representing the parameter values of local end-to-end streams, where said measuring appliances (Mi) implement different measuring processes, characterised in that it includes at least a management device (D) as in claim 1.

26. Use of the management device (D) and the communication network (N) as in claim 1 in the network technologies which have to be managed.

27. Use as in claim 26, characterised in that said network technologies are chosen from a group which includes transmission networks of the WDM, SONET or SDH type in particular, data of the IP-Internet or ATM type in particular, and speech of the conventional, mobile or NGN type in particular.
